(19) United States
(12) Patent Application Publication
(10) Pub. No.: US 2010/0232644 A1
(43) Pub. Date: Sep. 16, 2010

(54) SYSTEM AND METHOD FOR COUNTING THE NUMBER OF PEOPLE

(75) Inventors: Pei-Chi HSIAO, LUJHU TOWNSHIP (TW); Pang-Wei HSU, TAIPEI CITY (TW)

Correspondence Address: Muncy, Geissler, Olds & Lowe, PLLC, 4000 Legato Road, Suite 310, FAIRFAX, VA, 22033, US

(73) Assignee: MICRO-STAR INT'L CO., LTD

(21) Appl. No.: 12/555,373

(22) Filed: Sep. 8, 2009

(30) Foreign Application Priority Data
Mar. 12, 2009 (TW) 98108076

(51) Int. Cl. G06K 9/46; G06K 9/00

(52) U.S. Cl. 382/103; 382/192; 382/165

(57) ABSTRACT

This invention discloses a method and system for counting the number of people. First, a first face information is stored in a memory. Then, an image is determined to be a complexion region or not. The complexion region is determined to be a real face or not. Next, a one-to-one similarity matching is processed between the potential face information and the first face information, when the similarity matching achieves a predetermined condition, use the potential face information to update the first face information, when the similarity matching does not achieve a predetermined condition and the potential face is the real face, the potential face is viewed as a second face information and added to the memory, and the first face information is set as been occluded. Finally, the number of people in front of the camera is counted according to the faces stored in the memory.

### RELATED APPLICATIONS

This application claims priority to Taiwan Application Serial Number 98108076, filed Mar. 12, 2009, which is herein incorporated by reference.

### BACKGROUND

1. Field of Invention

The present invention relates to a system and a method for counting the number of people. More particularly, the present invention relates to a system and a method for counting and analyzing people that pass through the camera's field of view.

2. Description of Related Art

Digital signage has gradually replaced conventional billboards because of improvements in wireless communication and computer technology and the rapid decline in the cost of flat panel displays. Digital signage broadcasts both public information and commercial advertisements in Mass Rapid Transportation stations (MRT stations), airports, department stores and convenience stores. Therefore, the advertising market that the digital signage brought cannot be underestimated.

When advertisements are broadcast on a platform, we can use a corresponding strategy to measure how much people pay attention to them. In the web service, the number of clicks is recorded to know how many times the webpage have been visited. In TV commercial, the digital television setup box records information from the response of remote controls. Additionally marketers can use more traditional questionnaire type methods to learn about perceptions of products from consumers. However, questionnaires are costly and therefore the benefits and the cost have to be assessed to see whether questionnaires are the most cost effective method of determining perceptions about a product. Questionnaires generally have answers with deviations, which may or may not be caused by interviewers and questionnaire administrators administering in a non-uniform way or by people being impatient and not really paying proper attention to the questions in front of them. Therefore, when investigating what advertisements people prefer, the best way to acquire the results is to administer the questionnaires without interviewers and questionnaire administrators and enable people to feel as if they are in a more natural environment. When the results are less affected by the external factors, the reliability is increased.

A method for counting people that pass through a gate is raised in a prior art. In the method, a camera is set on the ceiling of the gate to record the number of people that pass through so that the number of people can be counted by recognizing how many independent objects move through the gate. However, the face cannot be recognized by the method mentioned above, so the number of people watching the advertisement at the same time cannot be acquired. In the other prior art, the number of people watching an advertisement at a given time is acquired with a face recognition device. Nevertheless, the prior art provides only the number of people watching the advertisement at a given time, and does not provide the function to further analyze the data for reference. Thus, in spite of having the function to count the number of people, if the degree that people like about the advertisement can be calculated, the benefit brought by the advertisement can be estimated more accurately.

### SUMMARY

The goal of this embodiment is to analyze the number of people watching an advertisement at any given time and then to estimate the benefit of the advertisement. To achieve this, the invention provides a system to count the number of people using skin complexion to select face candidates for further face identification and the system is assisted by a technology to track a plurality of faces. Furthermore, the information acquired can be used for further analysis. The number of people with different attention degree for the advertisement can be a basis for advertisement marketing.

Thus, the system and the method for counting the number of people is provided in the invention. The duration of each face looking at the advertisement is also calculated by determining how long the front face is pointed at the screen and being able to discern between the front face and a profile face. With the system and the method, we can fulfill the goal to count and analyze the number of people, and it can be applied to many different electronic devices.

Thus, one embodiment of the invention provides a system for counting the number of people in front of an electronic advertisement. The system for counting the number of people includes an object-tracking recorder, a complexion region detector, a face detector, a relevance-matching calculator and a counting calculator. The object-tracking recorder records a first face information in a first time point. The complexion region detector determines whether an image captured by a camera in a second time point is a complexion region, wherein the second time point follows the first time point. The face detector determines whether the complexion region is a real face, if the complexion region is a real face, the real face is determined to be a front face or a profile face, and the determined result is recorded as a potential face information. The relevance-matching calculator processes a one-to-one similarity matching between the potential face information and the first face information. When the similarity matching achieves a predetermined condition, the potential face information updates the first face information, when the similarity matching does not achieve the predetermined condition and the potential face is the real face, the potential face is viewed as a second face information and added to the object-tracking recorder, and the first face information is set as been occluded. The counting calculator counts the number of people in front of the camera according to the faces recorded by the object-tracking recorder.

Another embodiment of the invention provides a method for counting the number of people. First, a first facial information in a first time point is stored in a memory. Then, an image is determined to be a complexion region or not, wherein the image is captured by a camera in a second time point and the first time point is followed by the second time point. The complexion region is determined to be a real face or not, if the complexion region is a real face, the real face is determined to be a front face or a profile face, and the determined result is recorded as a potential face information. Next, a one-to-one similarity matching is processed between the potential face information and the first face information, when the similarity matching achieves a predetermined condition, the potential face information updates the first face information, when the similarity matching does not achieve a predetermined condition and the potential face is the real face, the potential face is viewed as the second face information and added to the memory, and the first face information is set as been occluded. Finally, the number of people in front of the camera is counted according to the faces stored in the memory.

An analysis graph for counting the number of people to display the number of people is used according to another embodiment of the invention. The analysis graph for counting the number of people to display the number of people includes an attention degree histogram, a people-to-time color bar and a multimedia interaction message board. The attention degree histogram includes a plurality of different colors in the histogram to indicate the attention degree of the number of people has been attracted by an advertisement on an digital signage. The people-to-time color bar includes a plurality of different colors to indicate the number of people in front of the camera in different time points.

As aforementioned, the invention analyzes the behaviors of the number of people in a more accurate way by determining whether the faces of the passers are front faces or profile faces respectively, and supplementing the face tracking technique. Furthermore, we may determine the face is occluded or has already left the camera's field of view by counting the number of times that the face has been occluded. The invention enables the advertisers to provide information and interact with the target customers in a more direct and accurate way, and extends to more related applications.

### BRIEF DESCRIPTION OF THE DRAWINGS

The invention can be more fully understood by reading the following detailed description of the embodiment, with reference made to the accompanying drawings as follows:

FIG. 1 illustrates a server of the people counting system according to one embodiment of this invention;

FIG. 1a illustrates a face detector of the people counting system according to one embodiment of this invention;

FIG. 1b illustrates an object-tracking recorder of the people counting system according to one embodiment of this invention;

FIG. 2 illustrates a flowchart of the people counting system according to one embodiment of this invention; and

FIG. 3 illustrates an analysis graph for counting the number of people according to one embodiment of this invention.

### DETAILED DESCRIPTION

The system for counting the number of people of this invention is applied to a plurality of electronic devices, and the fundamental of the system is to analyze the number of people by multiple face tracking. It is to be understood that the order of the steps mentioned in this embodiment, in spite of those described to be in a specific order, can be adjusted as needed, and can even be executed at the same time partially or totally.

The system for counting the number of people of this invention includes cameras and may include servers. The system is applied in digital signage and adopts distributed structures, which means the amount of each device can be above one. The systems can be connected through the Internet in order to form a bigger system, and thus can extend to other applications. The setting position of the cameras must prevent the camera lens being occluded by anything and enable the cameras to capture images correctly when the passers watch the advertisements on the digital signage. For example, the cameras can be set on the top, the left side and the right side of the digital signage.

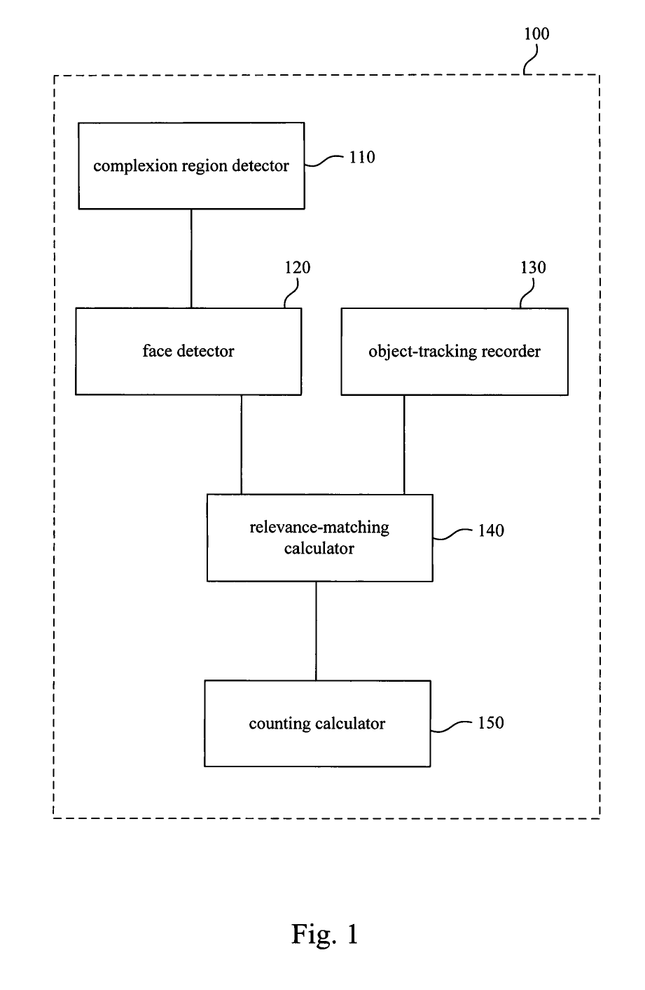

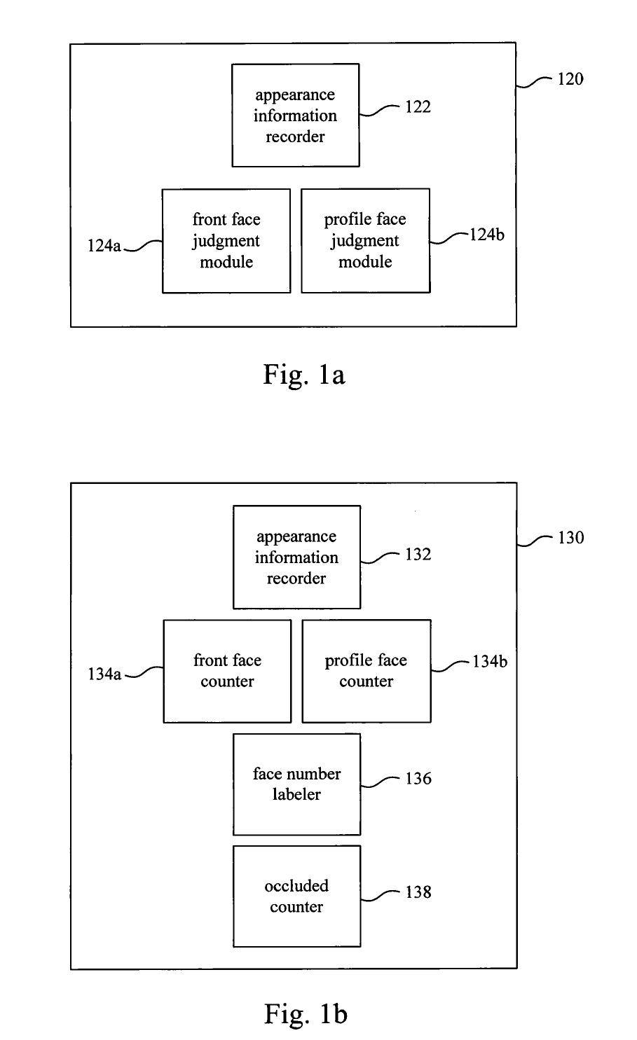

FIG. 1 illustrates a server 100 of the people counting system according to one embodiment of this invention. The server 100 includes an object-tracking recorder 130, a complexion region detector 110, a face detector 120, a relevance-matching calculator 140 and a counting calculator 150. The face detector 120 illustrated in FIG. 1a includes an appearance information recorder 122, a front face judgment module 124a and a profile face judgment module 124b. The object-tracking recorder 130 includes an appearance information recorder 132, a front face counter 134a, a profile face counter 134b, a face number labeler 136 and an occluded counter 138.

First, the camera extracts the images of the people passing through the field of view. Then, the complexion region detector 110 detects the complexion regions in the images. The complexion region detector 110 obtains a plurality of complexion regions using a known complexion region detecting and distinguishing method. For example, the appearance information of a region in an image is analyzed, including textures, colors and sizes, to obtain a plurality of complexion regions. When the complexion region detector 110 is detecting the complexion regions, the complexion region detector 110 does not cut one complexion region into different parts. For example, the complexion region of the face is not cut into the complexion region of the forehead, the complexion region of the nose and the complexion region of the cheeks. The complexion region of the hand is not cut into the complexion region of the five fingers, the complexion region of the back of the hands and the complexion region of the palms as well.

After obtaining the complexion regions, the face detector 120 determines whether the complexion regions are real faces or not. For example, the complexion region is compared with the relative positions of the facial features in an appearance information database, or the curves of the facial features are calculated. The results are recorded as potential face information. The face detector 120 also determines whether the potential face is a front face or a profile face. For example, the potential face information is compared with the relative positions of the facial features in an appearance information database, so the angle of the potential face relative to the camera lens is known therefore. There are four situations as following listed: The potential face is the front face, but is not the profile face; the potential face is not the front face, but is the profile face; the potential face is the front face, and is also the profile face; the potential face is not the front face, neither is the profile face.

If the potential face is determined to be a real face, the result for the face detector 120 determining the potential face is the front face or the profile face can represent the face is “watching” or “not watching” the advertisement now. For example: When the potential face is determined to be the real face and the front face, the real face is “watching” the advertisement now. When the potential face is determined to be the real face and the profile face, the real face is “not watching” the advertisement now. When the potential face is determined to be the real face, the front face and the profile face at the same time, it is defined that the real face is “watching” the advertisement now in this invention. To sum up, when the potential face is determined to be the real face, then the real face is the front face or the profile face. However, when the potential face is determined not to be the front face, neither to be the profile face, the potential face may partially be occluded so that the complete information cannot be obtained to distinguish the face.

In one embodiment, the potential face information of the face detector 120 in time t is defined as followed:

{Sₘ^{t}=1, . . . , M}, wherein M represents the amount of complexion regions detected by the complexion region detector 110.

In this embodiment, the face detector 120 records each of the potential face information (Sₘ^{t}) as followed:

appearance=texture, color, size, . . .

isFrontFace={true|false}

isProfileFace={true|false}

The face detector 120 records 1 to M potential face information in time t. Each of the potential face information records the appearance information of the potential face, and the information about whether the potential face is determined to be a front face or a profile face. In order to determine whether the potential face is the front face or the profile face, the potential face information is compared with the relative positions of the facial features in the appearance information database, so that the angle of the potential face relative to the camera lens now is known therefore.

appearance=texture, color, size, . . . , in this equation, the appearance information recorder 122 of the face detector 120 records the appearance information of the potential face, including textures, colors and sizes. The equation isFrontFace={true|false} means the front face judgment module 124a of the face detector 120 determines the result of isFrontFace, and the result may be true or false. If the result is true, the potential face is determined to be the front face, so the value 1 is obtained. If the result is false, the potential face is not determined to be the front face, so the value 0 is obtained. isProfileFace={true|false} means the profile face judgment module 124b of the face detector 120 determines the result of isProfileFace, and the result may be true or false. If the result is true, the potential face is determined to be the profile face, so the value 1 is obtained. If the result is false, the potential face is not determined to be the profile face, so the value 0 is obtained. For example, if the value obtained from the front face judgment module 124a is 1 and the value obtained from the profile face judgment module 124b is 0, the potential face is determined to be the front face, not the profile face; if the value obtained from the front face judgment module 124a is 0 and the value obtained from the profile face judgment module 124b is 1, the potential face is determined to be the profile face, not the front face; if the value obtained from the front face judgment module 124a is 1 and the value obtained from the profile face judgment module 124b is 1, the potential face is determined to be the front face, also is the profile face; if the value obtained from the front face judgment module 124a is 0 and the value obtained from the profile face judgment module 124b is 0, the potential face is determined not to be the front face, neither is the profile face.

The object-tracking recorder 130 can record a plurality of first face information in a plurality of time points, so that the calculation for face tracking can be processed by entering the potential face information of the face detector 120 and the first face information of the object-tracking recorder 130 into the relevance-matching calculator 140. The object-tracking can be realized by predicting the possible moving paths of the objects, or calculating the overlap degree of the complexion regions at different time points. We choose the following relevance-matching method to achieve the goal for detecting and tracking a plurality of faces in this invention.

In one embodiment, the first face information of the object-tracking recorder 130 in time t−1 is defined as followed:

{Tₙ^{t-1}|n=1, . . . , N}, wherein N is the amount of the faces.

In this embodiment, the first face information (Tₙ^{t-1}) of the object-tracking recorder 130 is defined as followed:

appearance=texture, color, size, . . .

numFrontFace=0

numProfileFace=0

FaceLabel=0

NumOccluded=0

The object-tracking recorder 130 mentioned above records 1 to N first face information in time t−1. Each of the first face information records the appearance information of the face, the number of times that the face information has determined as the front face, the number of times that the face information has been determined as the profile face, the face number and the number of times that a face has been occluded.

appearance=texture, color, size, . . . . In this equation, the appearance information recorder 132 of the object-tracking recorder 130 records the appearance information of the face, included textures, colors and sizes. The front face counter 134a of the object-tracking recorder 130 uses numFrontFace to count the number of times that a face information has been determined as the front face, wherein the initial value of the front face counter 134a is 0. Then, the value is increased by the front face judgment module 124a of the face detector 120. The profile face counter 134b of the object-tracking recorder 130 uses numProfileFace to count the number of times that a face information has been determined as the profile face, wherein the initial value of the profile face counter 134b is 0. Then, the value is increased by the profile face judgment module 124b of the face detector 120. The face number labeler 136 uses FaceLabel to label the tracking face numbers, wherein the initial value of the face number labeler 136 is 0. Then, the value is increased by the amount of the new tracking objects. When two tracking objects are occluded mutually, the exchange in the face numbers of the object-tracking recorder 130 may happen. However, the exchange in the face numbers does not affect the goal and the use of this invention. The occluded counter 138 uses NumOccluded to count the number of times that a face has been occluded. When the face cannot be detected, it is viewed as been occluded. When the number of times that the face has been occluded passes the threshold, it is viewed that the face has already left the camera's field of view.

The relevance-matching calculator 140 processes the one-to-one similarity matching between the potential face information and the first face information, wherein the face detector 120 defines the potential face information in the second time point, and the object-tracking recorder 130 defines the first face information in the first time point. The one-to-one similarity matching between the potential face information and the first face information is processed by the appearance information of the potential face information and the appearance information of the first face information. The percentage represents the similarity of the two, and then the percentage is compared with the threshold to determine whether the potential face information matches the first face information. The appearance information of the potential face and the appearance information of the first face include textures, colors and sizes, and the second time point follows the first time point.

When the similarity matching achieves the predetermined condition, the first face information in the first time point is updated by the potential face information in the second time point, and the second face information in the second time point is obtained. When the similarity matching does not achieve the predetermined condition and the potential face is the real face, the potential face in the second time point is viewed as the second face information in the second time point. Then, the second face information in the second time point is added to the object-tracking recorder 130, and the number of times that the first face information has been occluded is increased. When the number of times that the first face information has been occluded passes the threshold, the first face information has left the camera's field of view. Furthermore, the first face information mentioned above includes a plurality of face information. The embodiment followed illustrates the similarity matching between the potential face information and the first face information to obtain the second face information.

In this embodiment, when the similarity matching achieves the predetermined condition, the algorithm to update the first face information in the first time point by the potential face information in the second time point is defined as the following:

Tⱼ^{t}.appearance=Sᵢ^{t}.appearance

Tⱼ^{t}.numFrontFace=Tⱼ^{t-1}.numFrontFace+Sᵢ^{t}.isFrontFace

Tⱼ^{t}.numProfileFace=Tⱼ^{t-1}.numProfileFace+Sᵢ^{t}.isProfileFace

Tⱼ^{t}.numOccluded=0

When the similarity matching achieves the predetermined condition, the second face information in the second time point can be obtained with the relevance-matching calculator 140, wherein the relevance-matching calculator 140 updates the first face information by the potential face information in the second time point. In the algorithm of this embodiment, the first equation is Tⱼ^{t}.appearance=Sᵢ^{t}.appearance. In this equation, the appearance information of the potential face in the second time point (Sᵢ^{t}.appearance) replaces the appearance information of the first face in the first time point (Tⱼ^{t-1}.appearance). We may compare the difference between the appearance information of the face in two time points, such as the difference between the tenth time point and the first time point, and the difference between the second time point and the first time point. Deducing from general principles, the difference of the former has greater possibility to be bigger than the latter. Therefore, the appearance information of the potential face in the second time point replaces the appearance information of the first face in the first time point continually, so that the correctness of the second face information in the second time point (Tⱼ^{t}) can be increased.

The second equation is Tⱼ^{t}.numFrontFace=Tⱼ^{t-1}.numFrontFace+Sᵢ^{t}.isFrontFace, which means whether the potential face in the second time point is detected as the front face (Sᵢ^{t}.isFrontFace). The result may be true or false. When the result is true, the potential face in the second time point is detected as the front face, so the value 1 is obtained. When the result is false, the potential face in the second time point is not detected as the front face, so the value 0 is obtained. We may increase the number of times that the first face information in the first time point has been determined as the front face (Tⱼ^{t-1}.numFrontFace) with the value of whether the potential face information in the second time point is detected as the front face, so that the number of times that the second face information in the second time point has been determined as the front face (Tⱼ^{t}.numFrontFace) is obtained.

Next, the equation Tⱼ^{t}.numProfileFace=Tⱼ^{t-1}.numProfileFace+Sᵢ^{t}.isProfileFace means whether the potential face in the second time point is detected as the profile face (Sᵢ^{t}.isProfileFace). The result may be true or false. When the result is true, the potential face in the second time point is detected as the profile face, so the value 1 is obtained. When the result is false, the potential face in the second time point is not detected as the profile face, so the value 0 is obtained. We may increase the number of times that the first face information in the first time point has been determined as the profile face (Tⱼ^{t-1}.numProfileFace) with the value of whether the potential face information in the second time point is detected as the profile face, so that the number of times that the second face information in the second time point has been determined as the profile face (Tⱼ^{t}.numProfileFace) is obtained.

The last equation Tⱼ^{t}.numOccluded=0, which means the number of times that the second face information in the second time point has been occluded is set as 0, and increase the number of times been occluded. Then, whether the number of times been occluded achieves the threshold is determined, so that whether the face has left the camera's field of view can be determined correctly.

In one embodiment, when the similarity matching does not achieve the predetermined condition and the potential face is the real face, the potential face is viewed as a new tracking object and added to the second face information. Meanwhile, the object in the tracking list must be occluded, which means the first face information in the second time point (Tₖ^{t-1}) is set as been occluded, and the number of times that been occluded will be increased to update the second face information in the second time point (Tₖ^{t}). The algorithm is defined as following:

Tₖ^{t}.appearance=Tₖ^{t-1}.appearance

Tₖ^{t}.numFrontFace=Tₖ^{t-1}.numFrontFace

Tₖ^{t}.numProfileFace=Tₖ^{t-1}.numProfileFace

Tₖ^{t}.numOccluded=Tₖ^{t-1}.numOccluded+1

The first equation of the algorithm in this embodiment is Tₖ^{t}.appearance=Tₖ^{t-1}.appearance. After a tracking object cannot be detected, it is still viewed as the potential face in the second time point, and the appearance information of the potential face information (Tₖ^{t-1}.appearance) remains to be the appearance information of the second face information in the second time point (Tₖ^{t}.appearance).

In the equations Tₖ^{t}.numFrontFace=Tₖ^{t-1}.numFrontFace and Tₖ^{t}.numProfileFace=Tₖ^{t-1}.numProfileFace, the number of times that the tracking object has been determined as the front face (Tₖ^{t-1}.numFrontFace) and the tracking object has been determined as the profile face (Tₖ^{t-1}.numProfileFace) are remained to the second face information in the second time point. However, when Tₖ^{t}.numOccluded=Tₖ^{t-1}.numOccluded+1, the tracking object is viewed as been occluded by other objects. When the number of times been occluded passes the threshold, it is viewed as that the first face information has left the camera's field of view.

The second face information in the second time point recorded by the object-tracking recorder 130 is entered to the counting calculator 150 to calculate the number of people in front of the camera (numPasser) and the number of people watching the advertisement (numGaze). If the second face information is determined to be a new face, a face number is assigned to the second face information and the number of people in front of the camera is increased. If the second face information is determined to be a tracking object that has left, then whether the second face information has watched the digital signage is determined, and the number of people watching the advertisement is increased. The standard for determining whether the second face information has watched the digital signage is to examine whether the number of times has been occluded passes the threshold.

In one embodiment, the algorithm is shown as followed:

```
    input: numPasser, numGaze, T′ₙ, n = 1, ..., N
    output: numPasser′, numGaze′, T′_{n′}, n′ =1, ..., N′
    while n < N do
        if (( T′ₙ .numFrontFace !=0) || T′ₙ .numProfileFace != 0) and
(T′ₙ.FaceLabel == 0)
        then
                T′ₙ.FaceLabel = numPasser
                numPasser′ ← numPasser + 1
            if (T′ₙ.isOccluded > threshold)
            then
                if (T′ₙ.numFrontFace != 0)
                then
                numGaze′ ← numGaze + 1
      delete T′ₙ
      N′ ← N′ − 1
    n ← n + 1
```

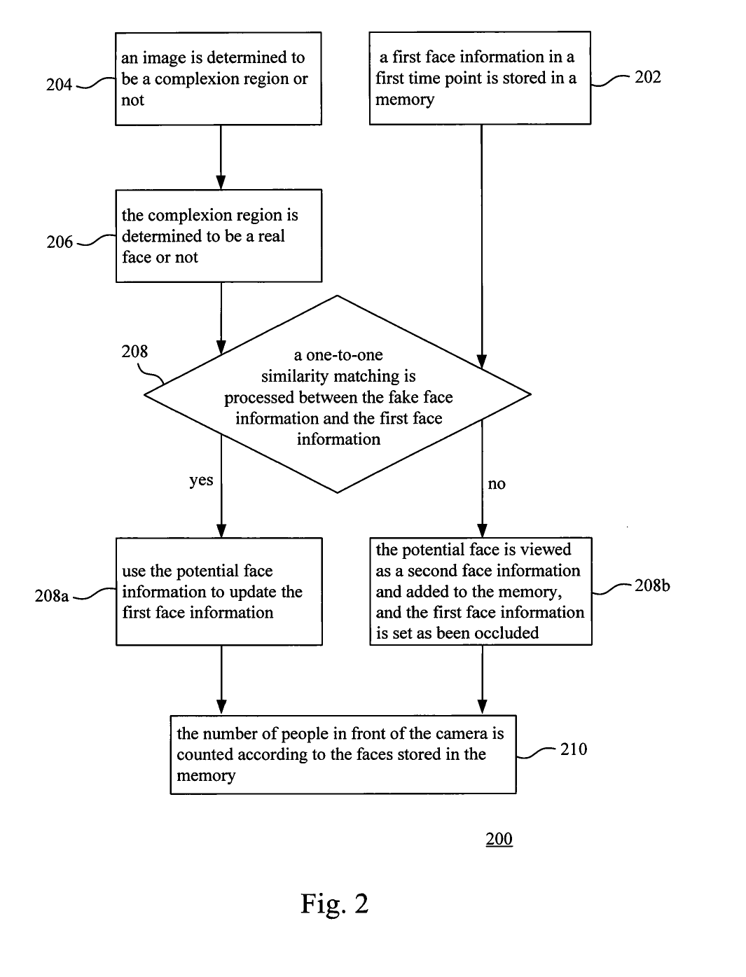

The method for counting the number of people is provided in this invention. Referred to the FIG. 2, it illustrates a flowchart 200 of the people counting system according to one embodiment of this invention. First, a first face information in a first time point is stored in a memory (step 202). Then, an image is determined to be a complexion region or not, wherein the first time point is followed by the second time point (step 204). The complexion region is determined to be a real face or not, if the complexion region is a real face, the real face is determined to be a front face or a profile face, and the determined result is recorded as a potential face information (step 206). Next, a one-to-one similarity matching is processed between the potential face information and the first face information (step 208). Finally, the number of people in front of the camera is counted according to the faces stored in the memory (step 210). In step 208, when the similarity matching achieves a predetermined condition, use the potential face information to update the first face information (step 208a). When the similarity matching does not achieve a predetermined condition and the potential face is the real face, the potential face is viewed as a second face information and added to the memory, and the first face information is set as been occluded (step 208b). First, in the step 202, a first face information in a first time point is stored in a memory. A plurality of first face information in a plurality of time points are recorded so that the similarity matching can be processed by entering the potential face information and the first face information. In order to track the first face information in a plurality of time points, the tracking method can make use of the possible moving paths of the objects or the repeating degree of the appearance information of the complexion regions. The similarity matching achieves the goal for detecting and tracking a plurality of faces in this invention.

In one embodiment, each of the first face information records the appearance information of the face, the number of times that the face information has determined as the front face, the number of times that the face information has been determined as the profile face, the face number and the number of times that a face has been occluded. The appearance information of the face, included textures, colors and sizes, and the face number labels the potential face determined to be the real face, wherein the initial value is 0. Then, the value is increased by the amount of the increasing tracking objects. When two tracking objects are occluded mutually, the exchange in the face numbers may happen. However, the exchange in the face numbers does not affect the goal and the use of this invention. In one exemplary embodiment of the invention, when the face cannot be detected, it is viewed as been occluded. When the number of times that the face has been occluded passes the threshold, it is viewed that the face has already left the recording region of the camera.

Then, in step 204, an image is determined to be a complexion region or not, wherein the first time point is followed by the second time point. The known complexion region detecting and distinguishing method is used in this step. For example, the appearance information of a region in an image is analyzed, including textures, colors and sizes, to obtain a plurality of complexion regions. When the image captured by the camera is detected to be the complexion region or not, one complete complexion region is not cut into different parts. For example, the complexion region of the face is not cut into the complexion region of the forehead, the complexion region of the nose and the complexion region of the cheeks. The complexion region of the hand is not cut into the complexion region of the five fingers, the complexion region of the back of the hands and the complexion region of the palms as well.

After obtaining the complexion regions, in the step 206, the complexion region is determined to be a real face or not, if the complexion region is a real face, the real face is determined to be a front face or a profile face, and the determined result is recorded as a potential face information. In one exemplary embodiment, in order to determine whether the complexion region is the real face, the complexion region is compared with the relative positions of the facial features in an appearance information database, or the curves of the facial features are calculated. Moreover, whether the potential face is a front face or a profile face is also determined. There are four situations as following listed: The potential face is the front face, but is not the profile face; the potential face is not the front face, but is the profile face; the potential face is the front face, and is also the profile face; the potential face is not the front face, neither is the profile face.

If the potential face is determined to be a real face, the meanings of the four situations mentioned above are listed as followed: When the potential face is determined to be the real face and the front face, the real face is “watching” the advertisement now. When the potential face is determined to be the real face and the profile face, the real face is “not watching” the advertisement now. When the potential face is determined to be the real face, the front face and the front face at the same time, it is defined that the real face is “watching” the advertisement now in this invention. To sum up, when the potential face is determined to be the real face, then the real face is the front face or the profile face. However, when the potential face is determined not to be the front face, neither to be the profile face, the potential face is partially occluded so that the complete information cannot be obtained to distinguish the face.

Next, in step 208, a one-to-one similarity matching is processed between the potential face information in the second time point and the first face information in the first time point. The one-to-one similarity matching between the potential face information and the first face information is processed by the appearance information of the potential face information and the appearance information of the first face information. The percentage represents the similarity of the two, and then compared with the threshold to determine whether the potential face information matches the first face information. The appearance information of the potential face and the appearance information of the first face include textures, colors and sizes, and the second time point follows the first time point.

The step 208a is processed when the similarity matching achieves the predetermined condition, the first face information in the first time point is updated by the potential face information in the second time point, and the second face information in the second time point is obtained.

The step 208b is processed when the similarity matching does not achieve the predetermined condition and the potential face is the real face. The potential face in the second time point is viewed as the second face information in the second time point. The number of times that the first face information has been occluded is increased. Furthermore, the first face information mentioned above includes a plurality of face information.

Finally, in the step 210, the number of people in front of the camera is counted according to the faces stored in the memory. If the second face information is determined to be a new face, a face number is assigned to the second face information and the number of passers is increased. If the second face information is determined to be a tracking object that has left, then the number of people watching is increased once whether the second face information has watched the digital signage. The standard for determining whether the second face information has watched the digital signage is to examine whether the second face information has been detected as the front face.

The advantage of the multiple faces detecting and tracking in this invention is to lock the complexion regions quickly by detecting the front face and the profile face, and the complexion regions are determined to be the real faces or not. When processing the face tracking, the faces occluded for a short while is endurable to reduce misjudgments. The information mentioned below can be obtained by the system for counting the number of people: the number of people in front of the camera passes the camera (numPasser), and the information of the number of people watching the digital signage (numGaze). When each tracking face leaves the camera's field of view, the members of face information, numFrontFace and numProfileFace, which represent the time of watching and not watching the digital signage respectively, are used for analyzing the relations between the number of people and the advertisement benefit.

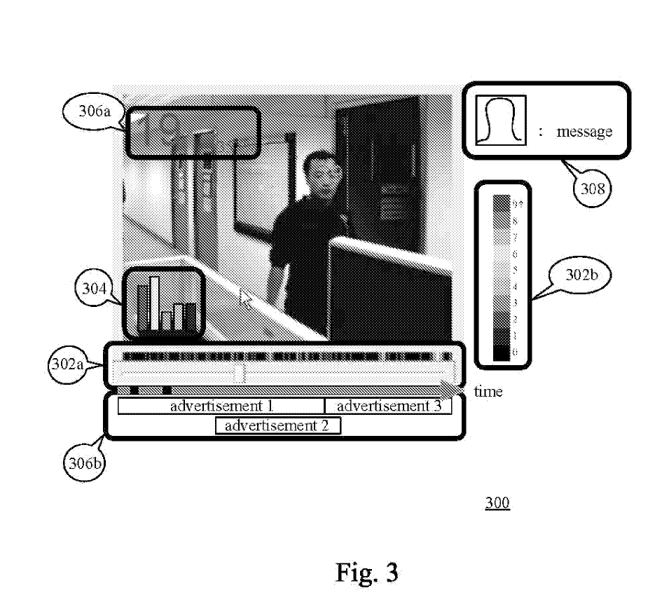

FIG. 3 illustrates an analysis graph 300 for counting people. In this invention, the exemplary embodiment for three analytical methods about counting the number of people and the application of multimedia interaction is provided. The analysis graph for counting the number of people 300 includes a people-to-time color bar 302a, an attention degree histogram 304, an advertisement-attracting index 306a and a multimedia interaction message board 308. The people-to-time color bar 302a further includes a number of people color bar 302b, and the advertisement-attracting index 306a further includes an advertisement benefit appraisal 306b.

The people-to-time color bar 302a uses a plurality of colors to label the number of people in front of the camera, wherein the labeling position is located in different time points on the timing axis. The different colors expressed by the number of people color bar 302b represent the number of people on the people-to-time color bar 302a. With the different colors and the time axis, we may generally know the popular and unpopular time in real time. The people-to-time color bar 302a can be displayed or hidden. In FIG. 3, ten different colors represent the number of people from 0 to 9. However, the number of people does not limited by this embodiment.

The attention degree histogram 304 represents the attention degree that the passers watch the digital signage, wherein the attention degree histogram 304 can be divided into 5 degrees according to the attention degree: large, medium large, medium, medium small and small. The attention degree histogram 304 is expressed with the colorful histogram instead of being expressed with the numbers. The five degrees are obtained by calculating the percentage of the time that the faces “watch” or “not watch” the digital signage, then the results are conversed to the five degrees.

In one exemplary embodiment, the formula for the five degrees is shown as followed:

$$\frac{numFrontFace}{numFrontFace + numProfileFace}$$

The advertisement-attracting index 306a shows how much is the attraction of the advertisement for the passers when the advertisement is broadcasting. The advertisement-attracting index 306a belongs to the advertisement benefit appraisal 306b. The advertisement-attracting index 306a is obtained by the number of the people in the camera's field of view in a certain period of time (numPasser), and the number of people who are watching the electronic signage (numGaze). The formula is shown as followed:

$$\frac{numGaze}{numPasser}$$

If the certain period of time is defined to be a broadcasting period of time for an advertisement, the attraction of the broadcasting period of time for an advertisement can be obtained so that the quantified and more objective advertisement benefit appraisal 306b can be obtained. Furthermore, a plurality of advertisements can be broadcasted at the same time, so, the broadcasting period of time for the advertisements can be listed according to the time axis in layers. The advertisement benefit appraisal 306b and the people-to-time color bar 302a are matched with each other to show the relevance between the number of people, the time and the advertisement benefit.

The multimedia interaction message board 308 may send the pictures or the visual voicemail to others when friends are reaching an appointment but cannot find each other. The search for partner matching is also an application. For example, the system finds a best partner before the digital signage after entering the matching requirements. The invention can be applied to generate random numbers to pick up award winners before the digital signage when there is a lottery held before the digital signage, which can also attracts the customers. Furthermore, the invention can be applied to find the missing dementia patients. After entering the patients' pictures into the system, it tracks automatically. If the system detects the goals, the alert rings to prompt the passers to provide help, or to connect with the police directly. The multimedia interaction message board 308 is just one example for local service application. With the function to detect the face watching the digital signage, the local service application can be developed. This can be distinguished from the service of mobile phones or the Internet connection by computers, and provides more friendly local service applications. First, the faces watching the digital signage is captured to be the potential customers, and shown on the right side of the detecting screen, as shown by the multimedia interaction message board 308. If any customer has interest in the advertisement, the customer can require for service by bluetooth, sending short messages on the mobile phones or clicking the picture on one's own picture on the touch panel, which is transferred by the wireless connection technology. Therefore, the system can reply different requests and establish the communication with the customers, so that the interaction application can be developed. The applications of the invention cannot only let each customer to operate, but also can provide personal service for each customer. The embodiments mentioned above are all based on the invention, so the commercial value of the invention cannot be underestimated.

We may know the strengths to apply the invention from the embodiments mentioned above. The invention provides a quantification and analysis method applied on counting the number of people that watch the digital signage. After obtaining the tracking information of a plurality of faces, the evaluation for advertisement benefit is processed. The prior arts based on the face recognition technology can only detect the amount of faces in each time point. Comparing to the prior arts, the invention can track the faces. In spite of this, the invention can obtain the information of passers that watching advertisements, and generate the histogram about the attention degree. Besides, the relevance between the number of people and the advertisement is expressed by the color bars and time axis, so the evaluation of the advertisement benefit is provided visually, thereby the advertisers can make the best choice.

The invention can be applied to industrial computers as digital signage. It can provide the advertisers a more objective and accurate evaluation of advertisement benefit to make the better choice of the advertising time, and can make their self-produced industrial computers become more valuable. The invention belongs to the leading end and intelligent technology, in spite of being applied to security monitoring, it can be developed in the applications of multimedia interaction and thus provide various kinds of commercial services. Since the invention uses the webcams to monitor visually, it can automatically process monitoring in long term, so it can be easily spread to the security monitoring on the exhibitions. Furthermore, the invention processed the evaluation of the advertisement benefit automatically, so it can provide the least cost and the best benefit. In the invention, the spectators do not need to stand in the special region to be detected, or wear any wireless sensor. Thus, it can provide low cost and much practical use.

Although the present invention has been described in considerable detail with reference to certain embodiments thereof, other embodiments are possible. Therefore, it will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A system for counting the number of people, comprising:
an object-tracking recorder for recording a first face information in a first time point;
a complexion region detector for determining whether an image captured by a camera in a second time point is a complexion region, wherein the second time point follows the first time point;
a face detector for determining whether the complexion region is a real face, if the complexion region is a real face, the real face is determined to be a front face or a profile face, and the determined result is recorded as a potential face information;
a relevance-matching calculator for processing a one-to-one similarity matching between the potential face information and the first face information, when the similarity matching achieves a predetermined condition, the potential face information updates the first face information, when the similarity matching does not achieve the predetermined condition and the potential face is the real face, the potential face is viewed as a second face information and added to the object-tracking recorder, and the first face information is set as been occluded; and
a counting calculator for counting the number of people in front of the camera according to the faces recorded by the object-tracking recorder.

2. The system for counting the number of people of claim 1, wherein the face detector comprising:
an appearance information recorder for recording an appearance information of the potential face;
a front face judgment module for determining whether the potential face is a front face; and
a profile face judgment module for determining whether the potential face is a profile face.

3. The system for counting the number of people of claim 1, wherein when the potential face is determined to be the front face and the profile face at the same time, the face detector determines that the potential face is the front face.

4. The system for counting the number of people of claim 1, wherein the object-tracking recorder comprising:
an appearance information recorder for recording an appearance information of a face;
a front face counter for counting a number of times that a face information has been determined as the front face;
a profile face counter for counting a number of times that a face information has been determined as the profile face;
a face number labeler for labeling each potential face determined to be the face; and
an occluded counter for counting a number of times that a face has been occluded.

5. The system for counting the number of people of claim 1, wherein the relevance-matching calculator processes the one-to-one similarity matching by the appearance information of the potential face information and the appearance information of the first face in the first time point.

6. The system for counting the number of people of claim 5, wherein the appearance information comprising textures, colors and sizes.

7. The system for counting the number of people of claim 5, wherein a plurality of the first face information are comprised in the first time point.

8. The system for counting the number of people of claim 4, wherein when the number of times that the face has been occluded exceeds a threshold, the first face information is viewed as leaving the camera's field of view.

9. The system for counting the number of people of claim 1, further comprising at least one digital signage.

10. The system for counting the number of people of claim 9, wherein the number of people can be displayed on the digital signage, and the number of people is counted by the counting calculator.

11. A method for counting the number of people, comprising:
a first face information in a first time point is stored in a memory;
an image is determined to be a complexion region or not, wherein the image is captured by a camera in a second time point and the first time point is followed by the second time point;
the complexion region is determined to be a real face or not, if the complexion region is a real face, the real face is determined to be a front face or a profile face, and the determined result is recorded as a potential face information;
a one-to-one similarity matching is processed between the potential face information and the first face information, when the similarity matching achieves a predetermined condition, use the potential face information to update the first face information, when the similarity matching does not achieve a predetermined condition and the potential face is the real face, the potential face is viewed as a second face information and added to the memory, and the first face information is set as been occluded; and
the number of people in front of the camera is counted according to the faces stored in the memory.

12. The method for counting the number of people of claim 11, wherein when the real face is determined to be a front face and a profile face at the same time, the real face is determined to be the front face.

13. The method for counting the number of people of claim 11, further comprising:
a number of times that a face information has been occluded is counted.

14. The method for counting the number of people of claim 11, wherein the one-to-one similarity matching is processed by an appearance information of the potential face information and an appearance information of the first face information.

15. The method for counting the number of people of claim 14, wherein the appearance information comprising textures, colors and sizes.

16. The method for counting the number of people of claim 13, wherein when the number of times that the face has been occluded exceeds a threshold, the first face information is viewed as leaving the camera's field of view.

17. The method for counting the number of people of claim 11, further comprising an analysis graph for counting the number of people to display the is number of people, wherein the analysis graph for counting the number of people comprising:
an attention degree histogram, a plurality of different colors are used in the histogram to indicate the attention degree of people has been attracted by an advertisement on an electronic signage;
a people-to-time color bar, a plurality of different colors indicates the number of people in front of the camera in different time points; and
a multimedia interaction message board.
